(19) United States
(12) Patent Application Publication
(10) Pub. No.: US 2005/0186401 A1
(43) Pub. Date: Aug. 25, 2005

(54) Washable, paintable cloth

(76) Inventor: Hsiu-Chun Chen, Lujhou City (TW)

Correspondence Address: RABIN & BERDO, P.C., Suite 500, 1101 14th Street, N.W., Washington, DC, 20005, US

(21) Appl. No.: 10/887,090

(22) Filed: Jul. 9, 2004

(30) Foreign Application Priority Data
Feb. 19, 2004 (TW) 093202352

(51) Int. Cl. B32B 3/00

(52) U.S. Cl. 428/195.1

(57) ABSTRACT

In light of the above, this innovator gathered rich experience accumulated from R&D and production of related products through the years, aiming at conventional paper's shortcoming of first, unrecyclability by cleansing and second, paper's flatness of a dull monotonous form, actively studied and improved, through the R&D process of meditation, trial production, experiment and modification etc., finally had completed with the proof of well tested samples, a washable paintable cloth (structure) readily cleansable of its surface colorants, with which to increase the playful interest in painting, raising the fun and training value of painting, and ready washable—recyclable, very environment friendly and economically effective in saving cost of paper, achieving the objective of educating through playing.

### [1] FIELD OF THE INVENTION

This innovation relates to a washable paintable cloth, especially referring to an innovation breaking through the convention mainly with paper as the material for painting, using pongee as the principal material, adapted with water-proof material as its filler for sewing into 3D objects of various shapes (such as albums, picture frames and cloth dolls etc.), and printed onto their surface various pattern lines, for colorants of non-toxic water-soluble color pens or watercolors etc. to be used to directly spread and paint on this innovation, to cultivate the interest and ability of children in painting, and also for ready cleansing with water to recycle and re-use.

### [2] DESCRIPTION OF THE PRIOR ART

When children start to daub holding a pen, most of them daub and color on various papers with various color pens. Due to their youth, immature hand coordination and poor control of the pen, the desktop, floor, wall and even their body often get daubed. Not only is this hard to clean, but it also ruins the environment, causing parents trouble. Moreover, conventional painting material—such as painting paper, a paper product with fixed size and shape, is in its final state after daubing, is hardly washable, with mobbing or cleansing to remove the painted colors. So parents have to prepare a sizable amount of paper for them to daub. In the cultivation of the interest of children's painting, use of paper is a considerable waste. Due to these two reasons, young children's daubing continues to cause parents problems, finally defeating the supply of their painting environment and choking the painting talent and interest of the children.

### [3] SUMMARY OF THE NEW MODEL

A washable, paintable cloth mainly using pongee as its principal material, with a sewing technique adapting suitable water-proof material as a filler, to form 3D objects such as albums, picture frames and cloth dolls etc., and printed onto their surface proper Pattern lines, as a (basic) structure, for colorants of non-toxic water-soluble color pens or watercolors etc. to be used in directly spreading and painting on this innovation, to cultivate the interest and ability to paint in children, and also to easily clean with water, to recycle and re-use, providing an excellent painting environment for children, effectively reducing conventional daubing that causes environmental destruction and thus achieving economic material benefit.

### [4] BRIEF DESCRIPTION OF THE DRAWINGS

FIG. 1 is the apparent drawing of the embodiment of the produced album in the form of this innovation.

FIG. 2 is the sectional drawing of the embodiment of the produced album in the form of this innovation.

FIG. 3 is the drawing of the colored surface of the pattern lines of the embodiment of the produced album in the form of this innovation.

FIG. 4 is the apparent drawing of the embodiment of the produced cloth doll in the form of this innovation.

FIG. 5 is the sectional drawing of the embodiment of the produced cloth doll in the form of this innovation.

FIG. 6 is the drawing of the colored surface of the pattern lines of the embodiment of the produced cloth doll in the form of this innovation.

### [5] DESCRIPTION OF THE PREFERRED EMBODIMENT

In order for the honorable examiner to specifically understand the structural features and substantive effects in this innovation, hereto is described below, the preferred embodiment with the adapted drawings, for your reference:

This innovation mainly uses pongee as its principal material, with a sewing technique adapting suitable waterproof material (e.g. foaming EVA, plastic grains and polyester wool etc.) as filler, to form 3D objects of congee wrapping, with pattern lines printed onto their surface, proper to the significance of its shape.

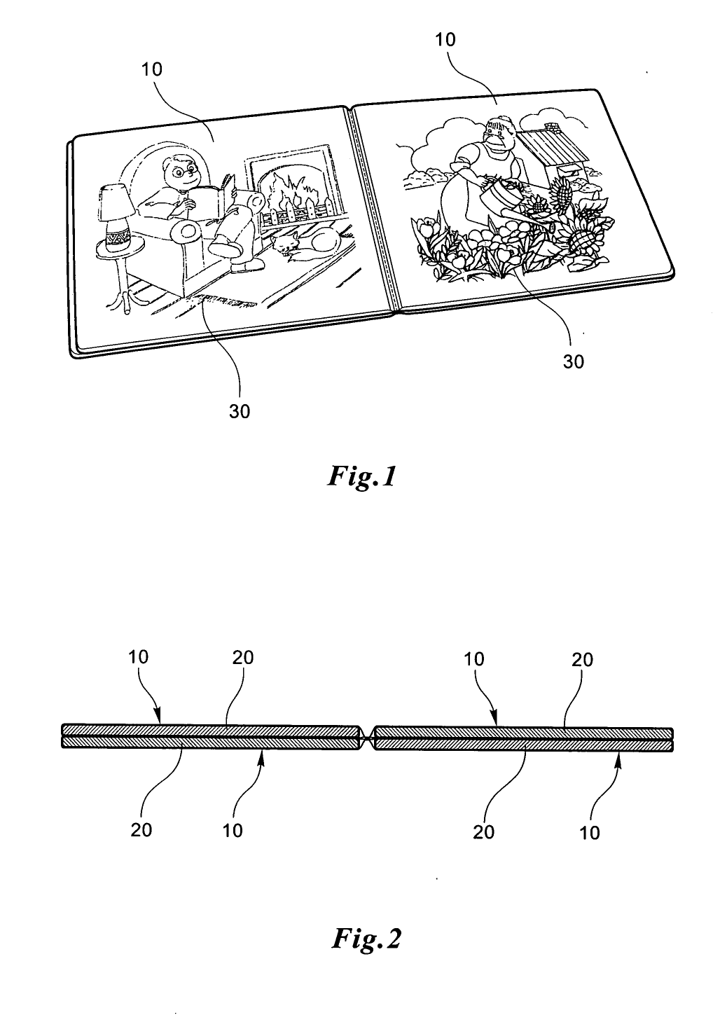

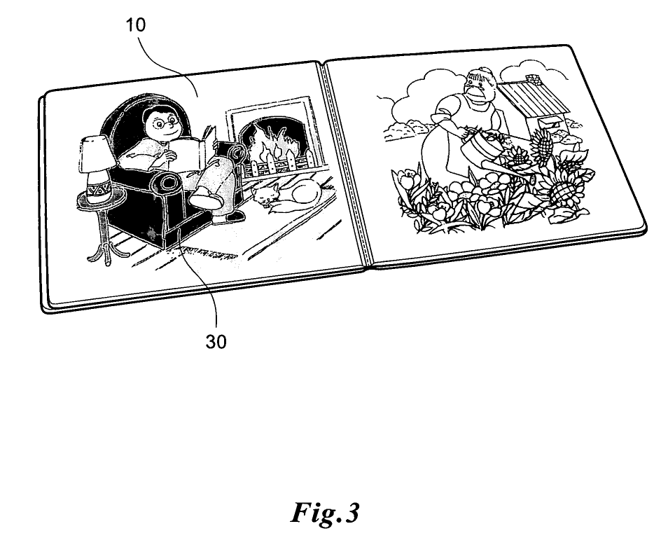

As shown in FIGS. 1 and 2, the embodiment of the produced album of This innovation, in which the surface wrapping is congee 10, and the album with every page with inner filler of foaming EVA 20, overall use of the sewing technique forming a plural-page album with every page with (obverse and reverse) faces printed with (inerasable) cute cartoon pattern lines 30; for children to daub and color, using non-toxic water-soluble color pens or watercolors, in the pattern lines 30 of this innovation, as shown in FIG. 3, to change the original black and white pattern into variegated colored pattern, increasing the fun of painting, raising children's interest and ability in painting; thus the painted color structure is readily washable and cleansed back to the printed black and white pattern lines 30, for further daubing, repeated recycled reuse.

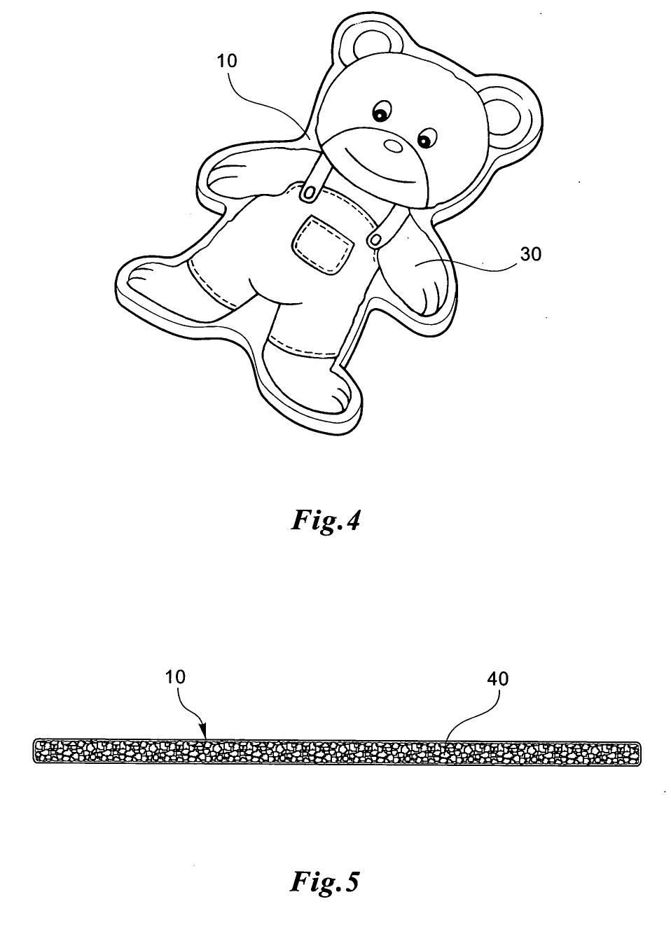

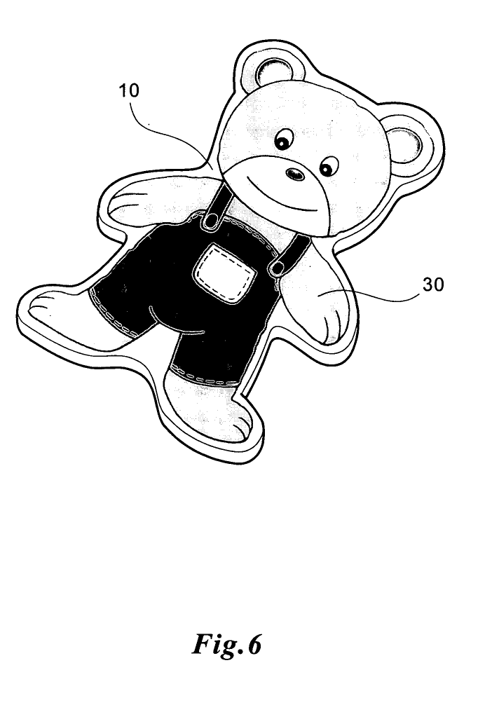

And as FIGS. 4 and 5 shows, produced 3D cloth doll embodiment of this innovation, in which the surface wrapping is pongee 10, inner filler is plastic grains 40, overall sewing forms a cute lovely 3D cloth doll, and on its (obverse and reverse) surface are printed pattern lines 30; in such structure, for the children to use a water-soluble color pen or water-color to daub and color on the pattern lines 30, as shown in FIG. 6, rendering the original black and white pattern changed into a vivid beautiful color pattern, as both the children's painting training material, and after painting for playing and decorative uses; and as the above example, said color painted cloth doll is readily washable, cleansed of all the painted color, to be further painted after drying: effective recycling gives economic benefits.

Summing up all the above, this innovation, with proper material adapted with the sewing technique, developed into a brand new paintable cloth with features widely different from that of the conventional painting paper, not only with improvement of the shortcomings of conventional painting paper daubing, but further achieving as a whole form a vivid 3D of paintable cloth, painted with color and readily washable repeatedly recyclable afterwards, substantially increasing children's interest and fun in painting, with the economic benefit of saving cost for consuming material (painting paper), for parents and children to build a fine painting environment together. And the brand new paintable cloth of this innovation is readily washable recyclable repeatedly reusable, very environmentally friendly, with the economic benefit of saving deforestation for conventional painting paper, thus achieving the goal of global environmental protection education in entertainment, meeting progress, improvement and practicality. Herein the patent of a new model is applied for, requesting your office to examine and in the innovator's hope, grant its patent.

1. This innovation mainly uses pongee as its principal material, with a sewing technique, adapting suitable water-proof material as the filler, to form 3D objects of congee wrapping, with the inner filler of water-proof material with pattern lines proper to the significance of its shape printed onto their surface.
